(19) United States
(12) Patent Application Publication
(10) Pub. No.: US 2011/0081016 A1
(43) Pub. Date: Apr. 7, 2011

(54) SECURE DATA COMMUNICATION USING ELLIPTIC CURVE CRYPTOLOGY

(75) Inventor: Walter KARGL, Graz (AT)

(73) Assignee: INFINEON TECHNOLOGIES AG, Neubiberg (DE)

(21) Appl. No.: 12/574,384

(22) Filed: Oct. 6, 2009

(51) Int. Cl. H04L 9/28; G06K 19/06; G06K 7/00; H04L 9/06

(52) U.S. Cl. 380/28; 235/492; 235/439; 380/277

(57) ABSTRACT

A contactless device including an contactless communication interface configured to receive a challenge from a contactless reader and a controller configured to generate an enciphered response using elliptic curve cryptology. Moreover, the enciphered response includes the challenge enciphered with a private key stored in non-volatile memory of the contactless device and data can be integrated as part of the challenge and/or the enciphered response.

### BACKGROUND

Radio-frequency identification (RFID) is an automatic identification method, which is based on storing and remotely retrieving data using devices called RFID tags or transponders. Generally, RFID systems provide communication between an RFID reader and a transponder. The information stored in memory of the transponder may be sensitive data such as financial data, security data or the like. Accordingly, it is important for the RFID reader to verify the authentication of the transponder and vice versa.

One technique employed to enable secure communication between an RFID reader and a transponder utilizes challenge-response authentication. Challenge-response authentication is a family of protocols in which one party presents a question (“challenge”) and another party provides an answer (“response”) to be authenticated. In some implementations of this technique, an encryption key is used to encrypt a randomly-generated number as the challenge, and, in response, the transponder will return a similarly-encrypted value which can be some predetermined function of the originally-offered information. As a result, the transponder has effectively proved that it was able to decrypt the challenge.

Once the RFID reader and transponder have verified the authenticity of one another, the two devices may subsequently communicate with each other by implementing standard communication protocols, such as those defined by the International Organization for Standardization (“ISO”). Such standards include ISO standard 14443, ISO standard 15693, ISO standard 18000 and the like. In conventional systems, after the challenge and response have been authenticated, data communication employing any of these communication standards is transmitted in an unsecure manner. As a result, conventional communication techniques between a reader and transponder remain susceptible to security attacks using methods such as emulator replacement.

### BRIEF DESCRIPTION OF THE DRAWINGS

FIG. 1 illustrates a block diagram of a contactless device in accordance with an exemplary embodiment.

FIG. 2 illustrates a block diagram of a secure communication system in accordance with an exemplary embodiment.

FIG. 3 illustrates a flowchart for a method for secure communication in accordance with an exemplary embodiment.

### DETAILED DESCRIPTION

The present application is directed to a system and method of secure communication between a contactless reader and one or more contactless devices. More specifically, the application is directed to secure communication between a contactless reader and one or more contactless devices in which data is integrated as part of the actual challenge and/or response.

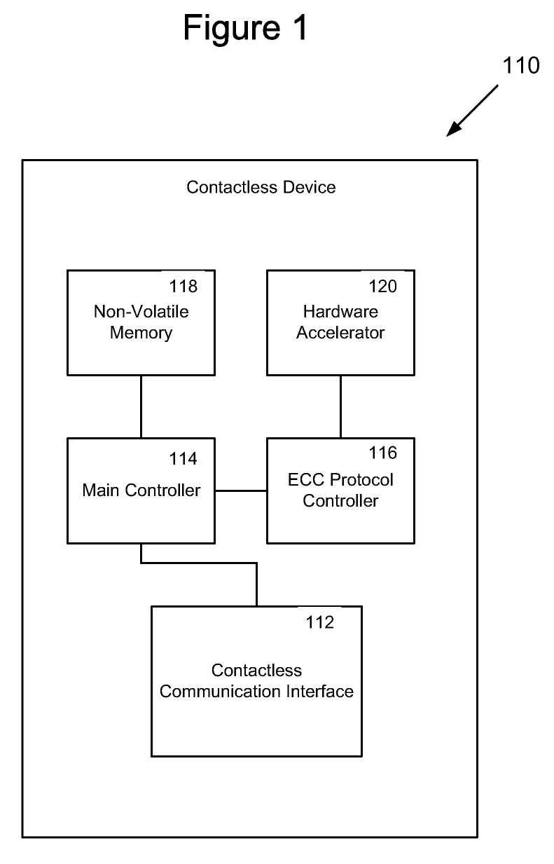

FIG. 1 illustrates a block diagram of contactless device 110 in accordance with an exemplary embodiment. In the exemplary embodiment, contactless device 110 can be a transponder. However, the application is not intended to be limited to transponders. Rather, the secure data communication described in the present application is capable of being applied for any device capable of contactless communication such as a tag, an RFID tag, a proximity IC card or the like.

As shown, contactless device 110 comprises contactless communication interface 112, main controller 114, elliptic curve cryptology (“ECC”) protocol controller 116, non-volatile memory 118 and hardware accelerator 120. Contactless communication interface 112 may comprise conventional contactless communication components such as an antenna and/or modem (not shown) and may be configured to transmit and receive signals to and from a contactless reader. As will be discussed in more detail below, data may be transmitted securely from a contactless reader to contactless device 110 and from contactless device 110 to a contactless reader.

Referring back to FIG. 1, main controller 114 is provided to control data communication of contactless device 110. In one embodiment, main controller 114 is a finite state machine. As is known to those of skill in the art, a finite state machine may be a programmable logic device, a programmable logic controller, logic gates and flip flops or relays, any other functional electronic logic circuitry, or any combination of these components. In another embodiment, main controller 114 may be a mini CPU or the like.

Contactless device 110 further comprises non-volatile memory 118 that is provided to store data, which is to be transmitted to and from a contactless reader. In addition, non-volatile memory 118 is provided to store a private key, a public key and a related certificate of the public key. As will be discussed in more detail below, all of these items stored in non-volatile memory 118 are provided to enable secure transactions of data. In an exemplary embodiment, non-volatile memory 118 comprises EEPROM (“Electrically Erasable Programmable Read-Only Memory”). However, non-volatile memory 118 may be any type of memory suitable for data storage for contactless device 110.

In addition, ECC protocol controller 116 is provided to control encryption of response signals that are transmitted to a contactless reader. Hardware accelerator 120 is coupled to ECC protocol controller 116 and is provided to increase the transaction speed of the response signal generation. It is noted that while main controller 114 and ECC protocol controller 116 are described in the exemplary embodiment of contactless device 110 as two separate components, in alternative embodiments, main controller 114 and ECC protocol controller 116 may be a single finite state machine, a single mini CPU or the like.

Furthermore, the application is not to be limited to ECC as the only encryption protocol employed and similar encryption methods are contemplated by the application. However, ECC is described in the exemplary embodiment because it is an asymmetric encryption method in which no system master key is needed. Moreover, the chip area and requisite power required by ECC protocol controller 18 is relatively small as compared with similar electronic components capable of encrypting data using other types of encryption methods.

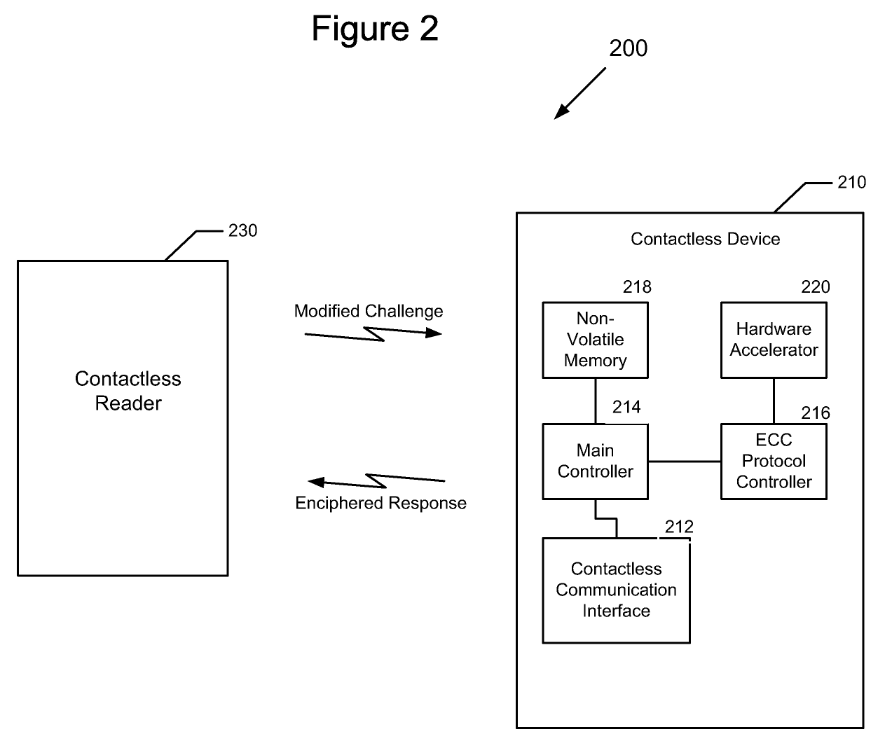

FIG. 2 illustrates a block diagram of a secure communication system in accordance with an exemplary embodiment. Specifically, the communication system 200 comprises contactless device 210 and contactless reader 230. In the exemplary embodiment of communication system 200, contactless device 210 is the exemplary contactless device described above with respect to FIG. 1. It is reiterated that contactless device 210 can be any type of low-cost electronic device capable of contactless communication, such as a transponder, an RFID tag or the like.

Furthermore, in order to avoid unnecessarily obscuring aspects of the application, components for contactless reader 230 are not shown in detail in FIG. 2. It should be noted, however, that contactless reader 230 of the present application is contemplated as comprising all of the requisite hardware components and applicable software necessary to perform the secure data communication with contactless device 210 as will be now be described.

In operation, communication system 200 enables data to be securely transmitted to and read from contactless device 210 by contactless reader 230. To transmit data to contactless device 210, contactless reader 230 initially generates a challenge that includes the data to be communicated to contactless device 210. Specifically, the data can be integrated as part of the challenge through an integration function. While the particular data integration function employed by the system engineer of the contactless reader 230 may vary, an aspect of the secure data communication is that the challenge incorporates some data that is to be transmitted to contactless device 210. For example, where a challenge employed in a conventional system is a random number, the modified challenge transmitted by contactless reader 230 may be a random number with data integrated as a part of the random number. Moreover, it should be understood that the challenge is not the same random number for every data communication transaction. Rather, in one embodiment, the challenge is a different randomly generated number for each data communication transaction.

As discussed with respect to FIG. 1, contactless device 210 employs contactless communication interface 212 capable of receiving the modified challenge. Upon receipt, main controller 214 identifies the data that is transmitted as part of the challenge and stores the data in non-volatile memory 218. Furthermore, main controller 214 generates a response to be transmitted back to contactless reader 230. Specifically, in conjunction with ECC controller 216, main controller 214 is configured to generate a response signal enciphered with a private key of contactless device 210. Hardware accelerator 220 is further provided to speed up the transaction time necessary to generate the enciphered response. Once generated, the enciphered response is then transmitted back to contactless reader 230 via antenna 212 and modem 214. In addition, the public key and related certificate, which are stored in non-volatile memory 218, are also transmitted to contactless reader 230.

Once contactless reader 230 receives the enciphered response, public key and related certificate, contactless reader 230 verifies the authenticity of contactless device 210. Specifically, contactless reader 230 is configured to verify that contactless device 210 correctly encrypted by decrypting the response using the public key. As a result, contactless reader 230 is able to ensure that contactless device 210 is in fact the device that contactless reader 230 intended to communicate with. Because contactless reader 230 may communicate with more than one contactless device, it is noted that the public key for each contactless device is stored in non-volatile memory 218 of that device. As a result, contactless reader 230 is not required to store the many, and potentially millions of, public keys for each respective contactless device for which it may communicate with. In an alternative embodiment, however, the public keys for each contactless device may be stored in memory of contactless reader 230.

In addition, the related certificate for the particular public key provides a second authenticity check after contactless reader 230 has verified that the response transmitted by contactless device 210 was encrypted correctly. As is known to those of skill in the art of cryptography, a public key certificate is an electronic document which incorporates a digital signature to bind together a public key with information such as the name of an organization or the like. Accordingly, contactless reader 230 uses the certificate transmitted from contactless device 210 to verify that the public key of contactless device 210 is part of the valid system.

Once contactless reader 230 has verified the response signal using the public key and further verified the public key by checking the public key certificate, contactless reader 230 can be sure that the data transmitted as part of the challenge was correctly transmitted to an authenticated contactless device. It should be understood that if either of these security checks fails, contactless reader 230 will recognize that the modified challenge was transmitted to an unauthenticated contactless device and, in response, may perform a predetermined action such as alerting an administrator of communication system 200 and/or terminating further communication with contactless device 210.

In addition to transmitting data to contactless device 210, data that is stored in non-volatile memory 218 of contactless device 210 can also be transmitted from contactless device 210 to contactless reader 230. To prompt this data communication, contactless reader 230 will initially transmit a challenge to contactless device 210 and, upon receipt, contactless device 210 will generate a response signal that may include data stored in non-volatile memory 218. More specifically, main controller 214 is configured to generate the response signal with the data in a similar manner as described above with respect to the modified challenge, meaning that data can be integrated on the response through an integration function. As noted above, while the particular data integration function may be designed by the system engineer of communication system 200, what is important is that the response signal incorporates some data that is to be transmitted to contactless device 230.

Moreover, ECC protocol controller 216 is configured to encipher this modified response with the private key stored in non-volatile memory 218 of contactless device 210. As discussed above, hardware accelerator 220 is provided to speed up the transaction time required to generate the enciphered response. Once the response signal has been enciphered, it is transmitted to contactless reader 230 via contactless communication interface 212. Furthermore, the public key and related certificate of contactless device 210 are also transmitted to contactless reader 230. When contactless reader 230 receives these items of data, contactless reader 230 decrypts the modified response signal and checks its authenticity in the same manner as discussed above. Contactless reader 230 is then capable of reading the data that is integrated as part of the response and using it accordingly.

In accordance with the foregoing embodiments, it should be clear that there are at least three possible data communication transactions by communication system 200. More particularly, data can be transmitted only as part of the modified challenge transmitted by contactless reader 230, only as part of the enciphered response transmitted by the contactless device 210, or both integrated as part of the modified challenge and integrated as part of the enciphered response.

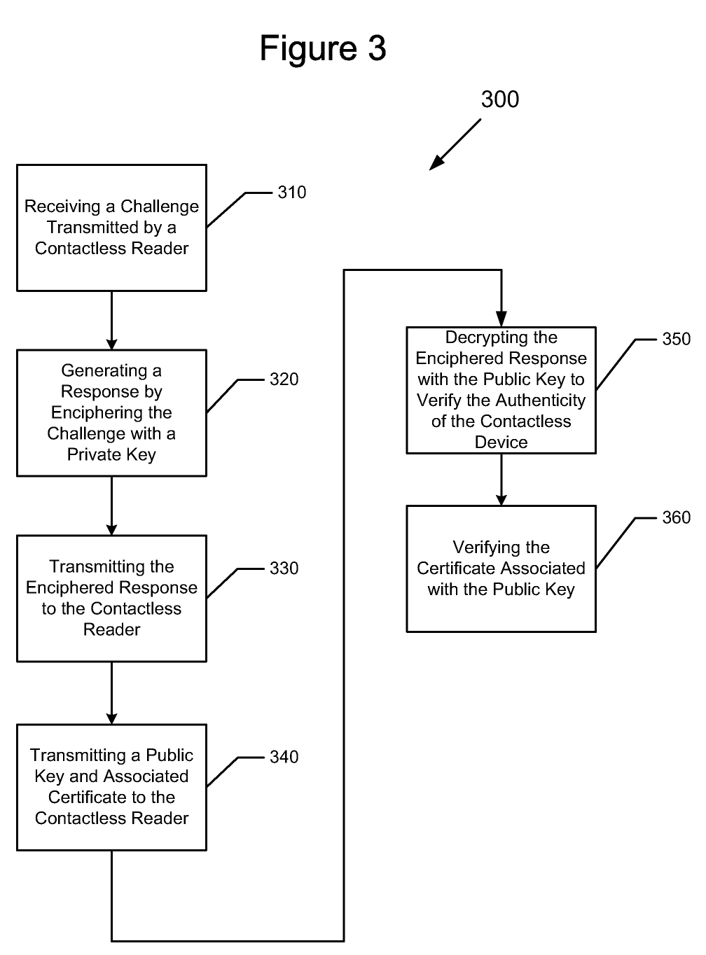

FIG. 3 illustrates a flowchart for a method 300 for secure communication in accordance with an exemplary embodiment. Initially, at Step 310, contactless device 210 receives a challenge transmitted from contactless reader 230. In one implementation, contactless reader 230 may integrate data as part of the challenge. At Step 320, main controller 214 of contactless reader 210 generates a response by enciphering the challenge with a private key that is stored in non-volatile memory 218. Moreover, ECC controller 216 is configured such that the enciphered response can be generated using elliptic curve cryptology. In another implementation, the enciphered response can further be integrated with data stored on non-volatile memory 218.

At Step 330, the enciphered response is transmitted to contactless reader 230 via contactless communication interface 212. Furthermore, a public key and associated certificate, which are stored in the non-volatile memory 218 of a contactless device 210, are transmitted to the contactless reader 230 via contactless communication interface 212 (Step 340). At Step 350, the contactless reader decrypts the enciphered response with the public key to verify the authenticity of the contactless device. Finally, at Step 360, the contactless reader further verifies the certificate associated with the public key.

While the foregoing has been described in conjunction with an exemplary embodiment, it is understood that the term “exemplary” is merely meant as an example, rather than the best or optimal. Accordingly, the application is intended to cover alternatives, modifications and equivalents, which may be included within the spirit and scope of the invention.

Additionally, in the preceding detailed description, numerous specific details have been set forth in order to provide a thorough understanding of the present invention. However, it should be apparent to one of ordinary skill in the art that the inventive test circuit may be practiced without these specific details. In other instances, well-known methods, procedures, components, and circuits have not been described in detail so as not to unnecessarily obscure aspects of the application.

What is claimed is:

1. A contactless device comprising:
a contactless communication interface configured to receive a challenge from a contactless reader; and
a controller configured to generate an enciphered response using elliptic curve cryptology, said enciphered response including the challenge enciphered with a private key that is stored in a non-volatile memory of the contactless device,
wherein data is integrated as part of at least one of the challenge and the enciphered response.

2. The contactless device of claim 1, wherein the data is integrated as part of the challenge by the contactless reader.

3. The contactless device of claim 2, wherein the controller is further configured to store the data in the non-volatile memory.

4. The contactless device of claim 1, wherein the controller is further configured to integrate the data, which is stored in the non-volatile memory, as part of the enciphered response.

5. The contactless device of claim 1, wherein the contactless communication interface is further configured to transmit the enciphered response to the contactless reader.

6. The contactless device of claim 1, wherein the controller is a finite state machine.

7. The contactless device of claim 1, wherein the controller is a mini central processing unit.

8. The contactless device of claim 1, wherein the contactless device is an radio-frequency identification (RFID) tag.

9. A communication system comprising:
a contactless reader configured to transmit a challenge; and
a contactless device comprising:
a contactless communication interface configured to receive the challenge; and
a controller configured to generate an enciphered response using elliptic curve cryptology, said enciphered response including the challenge enciphered with a private key that is stored in a non-volatile memory of the contactless device,
wherein data is integrated as part of at least one of the challenge and the enciphered response.

10. The communication system of claim 9, wherein the data is integrated as part of the challenge by the contactless reader.

11. The communication system of claim 9, wherein the controller is further configured to transmit, via the contactless communication interface, the enciphered response to the contactless reader.

12. The communication system of claim 11, wherein the controller is further configured to transmit, via the contactless communication interface, a public key stored in the non-volatile memory to the contactless reader.

13. The communication system of claim 12, wherein the controller is further configured to transmit, via the contactless communication interface, a certificate associated with the public key to the contactless reader.

14. The communication system of claim 12, wherein the contactless reader is further configured to decrypt the enciphered response with the public key such that the authenticity of the contactless device can be verified.

15. The communication system of claim 13, wherein the contactless reader is further configured to verify the certificate associated with the public key.

16. The communication system of claim 9, wherein the controller is further configured to integrate the data, which is stored in the non-volatile memory, as part of the enciphered response.

17. The communication system of claim 16, wherein the controller is further configured to transmit, via the contactless communication interface, the enciphered response to the contactless reader.

18. The communication system of claim 17, wherein the controller is further configured to transmit, via the contactless communication interface, a public key stored in the non-volatile memory to the contactless reader.

19. The communication system of claim 18, wherein the contactless reader is configured to decrypt the enciphered response with the public key such that the authenticity of the contactless device can be verified.

20. The communication system of claim 9, wherein the contactless device is an radio-frequency identification (RFID) tag.

21. A communication system comprising:
a contactless reader configured to transmit a plurality of challenges; and
a plurality of contactless devices each comprising:
a contactless communication interface configured to receive at least one of the plurality of challenges; and
a controller configured to generate an enciphered response using elliptic curve cryptology, said enciphered response including the respective challenge enciphered with a unique private key that is stored in non-volatile memory of the contactless device,
wherein data is integrated as part of at least one of the plurality of challenges and the respective enciphered response.

22. A communication method comprising:
receiving a challenge from a contactless reader;
generating a response using elliptic curve cryptology, by enciphering the challenge with a private key that is stored in a non-volatile memory; and
integrating data on at least one of the challenge and the enciphered response.

23. The communication method of claim 22, further comprising transmitting the response and a public key and associated certificate, which are stored in the non-volatile memory of a contactless device, to the contactless reader.

24. The communication method of claim 23, further comprising the contactless reader decrypting the enciphered response with the public key to verify the authenticity of the contactless device.

25. The communication system of claim 24, further comprising the contactless reader verifying the certificate associated with the public key.
